(19) United States
(12) Patent Application Publication
(10) Pub. No.: US 2025/0111458 A1
(43) Pub. Date: Apr. 3, 2025

(54) SYSTEM AND METHOD FOR RECOMBINING DIGITAL CLOTHES BASED ON BLOCKCHAIN

(71) Applicant: StyleAI Inc., Daejon (KR)

(72) Inventor: HA JEONG BAEK, Seoul (KR)

(21) Appl. No.: 18/860,292

(22) PCT Filed: Oct. 12, 2022
(86) PCT No.: PCT/KR2022/015358

§ 371 Date: Oct. 25, 2024

(30) Foreign Application Priority Data
May 2, 2022 (KR) 10-2022-0053984

(51) Int. Cl. G06Q 50/18; G06Q 20/38; G06Q 30/0601; G06T 11/60

(52) U.S. Cl. CPC G06Q 50/184; G06Q 20/389; G06Q 30/0643; G06T 11/60; G06T 2210/16

(57) ABSTRACT

A system for recombining digital clothes includes an image collection unit, an image analysis unit, a costume registration unit receiving registration of a new digital costume created, a non-fungible token (NFT) issuance unit issuing a first NFT, a virtual fitting unit authenticating ownership of the first NFT through a blockchain electronic wallet and activating a virtual fitting function for the new digital costume only for the user terminal for which authentication of the ownership has been completed, a sales management unit distributing a portion of the sales amount for the ownership to an original creator of the selected fashion image when the ownership of the first NFT of the user is sold, and an avatar creation unit receiving body information including a face shape, body shape, and body size of the user from the user terminal and creating a personalized avatar corresponding to the body information.

### BACKGROUND

### 1. Technical Field

The present invention relates to a technology for developing a virtual digital costume through design recombination and trading or producing make-to-order the digital costume based on a blockchain.

### 2. Background Art

Recently, the fashion market has been steadily growing due to the rise of various online shopping malls and people's increasing interest in fashion. In addition, the market for fashion items for game avatars, known as the skin market, is also estimated to be worth several billion dollars. With the rapid growth of the fashion and skin markets, various attempts related to fashion are being made, and as a part thereof, people's interest in and research and development of digital costumes are gradually increasing.

The digital costume is a virtual costume that exists in a virtual world, and cannot be worn in real life by itself and can only be worn virtually online. People are using various photo editing technologies on SNS, etc. to superimpose a new digital costume onto their photos, thereby expressing the same feeling as actually wearing the digital costume. It is expected that such a digital costume can be incorporated into the existing fashion industry to create greater added value. However, in order for the digital costume to be incorporated into the existing fashion industry and create significant added value, it is necessary to first overcome difficulties such as unauthorized duplication, transaction methods, difficulty in wearing of the digital costume, a make-to-order production method of making the digital costume into a real costume, etc.

### SUMMARY

Embodiments of the present invention are intended to provide a platform for identifying and classifying attributes of a fashion image and then issuing an NFT when a new digital costume according to modification of the attributes is created, and enabling virtual fitting, profit distribution according to a transfer of ownership of the new digital costume, make-to-order production of the new digital costume, etc. based on the NFT.

According to an exemplary embodiment, there is provided a system for recombining digital clothes based on blockchain including an image collection unit that collects a plurality of fashion images, an image analysis unit that analyzes each collected fashion image to identify attributes constituting each fashion image, a costume registration unit that receives a selection of one of the plurality of fashion images from a user terminal and receives, from the user terminal, registration of a new digital costume created as at least one of the attributes of the selected fashion image is transformed according to input of a user, a non-fungible token (NFT) issuance unit that issues a first NFT for the new digital costume, a virtual fitting unit that authenticates ownership of the first NFT through a blockchain electronic wallet and activates a virtual fitting function for the new digital costume only for the user terminal for which authentication of the ownership has been completed, and a sales management unit that distributes a portion of the sales amount for the ownership to an original creator of the selected fashion image when the ownership of the first NFT of the user is sold.

The attributes constituting each fashion image may include at least two or more of a material, a print, a style, a color, a shoulder line, a sleeve length, a neckline, a collar, a fit, a safe, and a silhouette.

The virtual fitting unit may load a virtual avatar having the most similar body shape and body size to a specific person or mannequin among a plurality of virtual avatars previously stored in a database when the user terminal photographs the specific person or mannequin through a photographing means, superimpose the new digital costume onto the virtual avatar in a virtual space, and then provide the superimposed augmented reality screen to the user terminal for which the authentication of the ownership has been completed.

The virtual fitting unit may change a pose of the virtual avatar to correspond to a pose of the specific person or mannequin, superimpose the new digital costume onto the virtual avatar in the virtual space, and then provide the superimposed augmented reality screen to the user terminal for which the authentication of the ownership has been completed.

The system for recombining digital clothes based on blockchain may further include an avatar creation unit that receives body information including a face shape, body shape, and body size of the user from the user terminal and creates a personalized avatar corresponding to the body information, and the NFT issuance unit may issue a second NFT corresponding to the personalized avatar, and ownership of the second NFT may be sold independently of the ownership of the first NFT.

The virtual fitting unit may superimpose the new digital costume onto the personalized avatar in a virtual space and then provide the superimposed augmented reality screen to a user terminal for which authentication of the ownership of the first NFT and the second NFT has been completed.

The system for recombining digital clothes based on blockchain may further include a make-to-order production unit that authenticates the ownership of the first NFT of the user terminal through the blockchain electronic wallet when receiving a make-to-order production request for the new digital costume from the user terminal, and transmits the make-to-order production request for the new digital costume to a set make-to-order production server only when the authentication of the ownership has been completed.

According to another exemplary embodiment, there is provided a method for recombining digital clothes based on blockchain including the steps of: collecting, by an image collection unit, a plurality of fashion images, analyzing, by an image analysis unit, each collected fashion image to identify attributes constituting each fashion image, receiving, by a costume registration unit, a selection of one of the plurality of fashion images from a user terminal, receiving, by costume registration unit, registration of a new digital costume, which is created as at least one of attributes of the selected fashion image is transformed according to input of a user, from the user terminal, issuing, by an NFT credit issuance unit, a first non-fungible token (NFT) for the new digital costume, authenticating, by a virtual fitting unit, ownership of the first NFT through a blockchain electronic wallet, activating, by the virtual fitting unit, a virtual fitting function for the new digital costume only for the user terminal for which authentication of the ownership has been completed, and distributing, by a sales management unit, a portion of the sales amount for the ownership to an original creator of the selected fashion image when the ownership of the first NFT of the user is sold.

The attributes constituting each fashion image may include at least two or more of a material, a print, a style, a color, a shoulder line, sleeve length, a neckline, a collar, a fit, a safe, and a silhouette.

The method for recombining digital clothes based on blockchain may further include, after the step of activating the virtual fitting function for the new digital costume, a step of loading, by the virtual fitting unit, a virtual avatar having the most similar body shape and body size to a specific person or mannequin among a plurality of virtual avatars previously stored in a database when the user terminal photographs the specific person or mannequin through a photographing means, superimposing the new digital costume onto the virtual avatar in a virtual space, and then providing the superimposed augmented reality screen to the user terminal for which the authentication of the ownership has been completed.

In the step of providing the augmented reality screen to the user terminal, a pose of the virtual avatar may be changed to correspond to a pose of the specific person or mannequin, the new digital costume may be superimposed onto the virtual avatar in the virtual space, and then the superimposed augmented reality screen may be provided to the user terminal for which the authentication of the ownership has been completed.

The method for recombining digital clothes based on blockchain may further include the steps of receiving, by an avatar creation unit, body information including a face shape, body shape, and body size of the user from the user terminal, creating, by the avatar creation unit, a personalized avatar corresponding to the body information, and issuing, by the NFT issuance unit, a second NFT corresponding to the personalized avatar, and in which the ownership of the second NFT may be sold independently of the ownership of the first NFT.

The method for recombining digital clothes based on blockchain may further include, after the step of creating the personalized avatar, a step of superimposing, by the virtual fitting unit, the new digital costume onto the personalized avatar in a virtual space and then providing the superimposed augmented reality screen to a user terminal for which authentication of the ownership of the first NFT and the second NFT has been completed.

The method for recombining digital clothes based on blockchain may further include the steps of authenticating, by a make-to-order production unit, the ownership of the first NFT of the user terminal through the blockchain electronic wallet when receiving a make-to-order production request for the new digital costume from the user terminal, and transmitting, by the make-to-order production unit, the make-to-order production request for the new digital costume to a set make-to-order production server only when the authentication of the ownership has been completed.

According to embodiments of the present invention, it is possible to provide a design recombination platform through which anyone can easily develop a new digital costume through design recombination, and improve the reliability of transactions and make-to-order production for the new digital costume based on a blockchain.

In addition, according to embodiments of the present invention, by exclusively activating the virtual fitting function (i.e., AR filter function) only to users for whom authentication of ownership of the first NFT of the new digital costume has been completed after the new digital costume is created, it is possible to provide exclusive useful information about the new digital costume to the user having the ownership of the new digital costume before the make-to-order production for the new digital costume.

In addition, according to embodiments of the present invention, it is possible to stably trade the ownership of the new digital costume and personalized avatar based on the first NFT and the second NFT, and provide the user who simultaneously purchases ownership of the first NFT and the second NFT with the same experience as if the user is actually wearing a new digital costume in the virtual world.

### BRIEF DESCRIPTION OF THE DRAWINGS

FIG. 1 is a schematic diagram for describing a digital costume recombination system according to an embodiment of the present invention.

FIG. 2 is a block diagram showing a detailed configuration of the digital costume recombination system according to an embodiment of the present invention.

FIG. 3 is an example showing a plurality of fashion images and attributes of the fashion images according to an embodiment of the present invention.

FIG. 4 is an example of selecting one of a plurality of fashion images according to an embodiment of the present invention.

FIG. 5 is an example of a new digital costume according to an embodiment of the present invention.

FIG. 6 is an example of providing, by a virtual fitting unit, an augmented reality screen created by superimposing a new digital costume onto a virtual avatar to a user terminal according to an embodiment of the present invention.

FIGS. 7A to 7C are examples showing a process of creating, by an avatar creating unit, a personalized avatar corresponding to body information of a user according to an embodiment of the present invention.

FIGS. 8A and 8B are examples of providing, by the virtual fitting section an augmented reality screen created by superimposing a new digital outfit onto a personalized avatar to a user terminal according to an embodiment of the present invention.

FIG. 9 is a flowchart for describing a digital costume recombination method according to a first embodiment of the present invention.

FIG. 10 is a flowchart for describing step S110 of FIG. 9.

FIG. 11 is a flowchart for describing a digital costume recombination method according to a second embodiment of the present invention.

FIG. 12 is a block diagram for describing a computing environment including a computing device suitable for use in exemplary embodiments.

### DETAILED DESCRIPTION

Hereinafter, a specific embodiment of the present disclosure will be described with reference to the drawings. The following detailed description is provided to aid in a comprehensive understanding of the methods, apparatus and/or systems described herein. However, this is illustrative only, and the present disclosure is not limited thereto.

In describing the embodiments of the present disclosure, when it is determined that a detailed description of related known technologies may unnecessarily obscure the subject matter of the present disclosure, a detailed description thereof will be omitted. Additionally, terms to be described later are terms defined in consideration of functions in the present disclosure, which may vary according to the intention or custom of users or workers. Therefore, the definition should be made based on the contents throughout this specification. The terms used in the detailed description are only for describing embodiments of the present disclosure, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

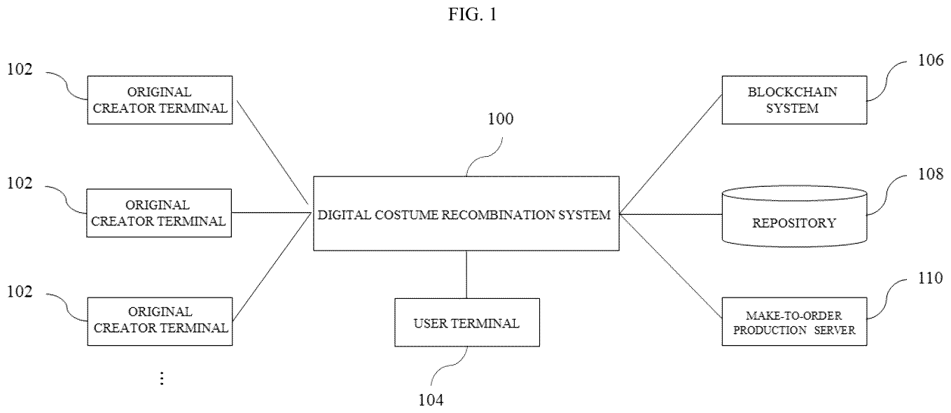

FIG. 1 is a schematic diagram for describing a digital costume recombination system according to an embodiment of the present invention. As shown in FIG. 1, a digital costume recombination system 100 is connected to each of a plurality of original creator terminals 102, a user terminal 104, a blockchain system 106, a repository 108, and a make-to-order production server 110.

The original creator terminal 102 is a terminal possessed by an original creator of a fashion image, and may be, for example, a desktop computer, a notebook computer, a tablet computer, a smartphone, a PDA, a wearable device such as a smart watch, etc. The original creator terminal 102 may transmit the fashion image to the digital costume recombination system 100. In the present embodiments, the fashion image is used in a broad sense including not only a real costume image but also a digital costume image. In addition, the fashion image may be formed as a two-dimensional or three-dimensional file. A plurality of original creator terminals 102 may exist, and the digital costume recombination system 100 may collect a plurality of different fashion images from each of the original creator terminals 102. In this case, the digital costume recombination system 100 may collect information of the original creator who created the fashion image together with the fashion image from the original creator terminal 102. After that, the digital costume recombination system 100 may analyze the collected fashion images to identify and classify attributes constituting each fashion image. Here, the attributes may be, for example, a material, a print, a style, a color, a shoulder line, a sleeve length, a neckline, a collar, a fit, a safe, a silhouette, etc.

The user terminal 104 may be a terminal possessed by a user, and may be, for example, a desktop, a notebook, a tablet computer, a smartphone, a PDA, a wearable device such as a smart watch, etc. The user may access a design recombination platform provided by the digital costume recombination system 100 through the user terminal 104, and may select one of the plurality of fashion images from the design recombination platform. The user may modify at least one of the attributes of the fashion image selected through various design tools, design development programs, etc. online, and may develop a new digital costume of a new style through such modification. Such a new digital costume may be regarded as a secondary creation created) from the fashion image of the original creator terminal 102. The digital costume recombination system 100 may receive registration of the new digital costume from the user terminal 104 and issue a first non-fungible token (NFT) for the new digital costume.

The blockchain system 106 manages digital assets in the form of tokens created through a smart contract. The tokens may be divided into fungible tokens that can be exchanged with other tokens of the same type, and non-fungible tokens, i.e. NFTs, that have a unique ID for each token and cannot be exchanged with other tokens. When receiving the registration of the new digital costume from the user terminal 104, the digital costume recombination system 100 may issue the first NFT corresponding to the new digital costume and store (connect) the first NFT in (to) the blockchain system 106. Here, the first NFT may include a unique ID corresponding to the new digital costume, information on the original creator of the fashion image that became the basis of the new digital costume or an original creator terminal 102, and information on a user who created the new digital costume or the user terminal 102. The digital costume recombination system 100 may store the first NFT for the new digital costume in the blockchain system 106, and store an original file of the new digital costume and metadata of the new digital costume in the repository 108.

The repository 108 is a storage existing outside the blockchain system 106, and may be, for example, a distributed file system (IPFS: InterPlanetary File System). The storage 108 may be larger in storage capacity than the blockchain system 106. Accordingly, the digital costume recombination system 100 may interconnect the first NFT and the original file and metadata of the new digital costume, and then store the same in a distributed manner in the blockchain system 106 and the repository 108, respectively.

The make-to-order production server 110 is a server that manages make-to-order production for the new digital costume. Since the new digital costume exists in the form of a 3D file online, make-to-order production for the new digital costume is required to receive a real product for the new digital costume. However, in order to prevent indiscriminate making of make-to-order production by users who do not have ownership of the new digital costume, the present invention allows only the make-to-order production requested by the user whose ownership of the new digital costume is authenticated through the first NFT to be transmitted to the make-to-order production server 110. To this end, the digital costume recombination system 100 may authenticate the ownership of the first NFT of the user terminal 104 through a blockchain electronic wallet when receiving a make-to-order production request for the new digital costume from the user terminal 104. The blockchain electronic wallet may be composed of a public key used to create a wallet address consisting of a combination of a plurality of characters and numbers, and a private key used to create and sign transaction data recorded in a distributed ledger of the blockchain system 106. The private key of the blockchain electronic wallet may be used to make a digital sign for authenticating ownership of digital assets, i.e., the first NFT of the new digital costume. The digital costume recombination system 100 may authenticate the ownership of the first NFT of the user terminal 104 through the blockchain electronic wallet when receiving a make-to-order production request for the new digital costume from the user terminal 104, and transmits the make-to-order production request for the new digital costume to a set make-to-order production server 110 only when the authentication of the ownership has been completed. After that, the make-to-order production server 110 may obtain the original file and metadata of the new digital costume from the repository 108 according to the make-to-order production request, and transmit the original file and metadata to a set factory server (not shown) to request make-to-order production of the real product for the new digital costume.

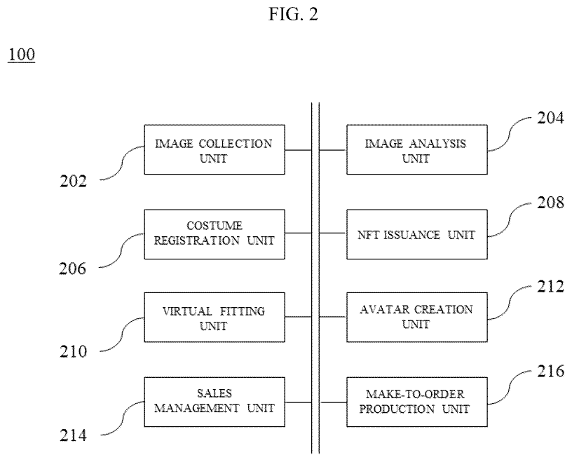

FIG. 2 is a block diagram showing a detailed configuration of the digital costume recombination system 100 according to an embodiment of the present invention. As shown in FIG. 2, the digital costume recombination system 100 according to an embodiment of the present invention includes an image collection unit 202, an image analysis unit 204, a costume registration unit 206, an NFT issuance unit 208, a virtual fitting unit 210, an avatar creation unit 212, a sales management unit 214, and a make-to-order production unit 216.

The image collection unit 202 collects a plurality of fashion images from each of the original creator terminals 102. As described above, the image collection unit 202 may collect, from the original creator terminal 102, information about an original creator who created the fashion image together with the fashion image.

The image analysis unit 204 analyzes each collected fashion image to identify attributes constituting each fashion image. Here, the attributes may be, for example, a material, a print (pattern), a style, a color, a sleeve length, a neckline, a collar, a fit, a safe, a silhouette, etc. of the fashion image. Here, the material may be, for example, cotton, polyester, linen, rayon, tencel, acrylic, fur, knit, mouton, lace, suede, angora, mesh, corduroy, fleece, sequin, neoprene, denim, silk, jersey, spandex, tweed, jacquard, velvet, leather, vinyl, cotton, wool, chiffon, synthetic, etc. In addition, the print may be, for example, check, floral, stripe, lettering, zigzag, skull, leopard, tie-dye, camouflage, graphic, paisley, Hound's touth, argyle, gingham, etc. In addition, the style may be, for example, casual, street, vintage, feminine, dandy, classic, menish, elegance, ethnic, modern, natural, romantic, sporty, newtro, hip hop, maximum, punk, etc. The color may be, for example, white, black, blue, red, or the like. In addition, the safe may be, for example, asymmetrical, a-line, h-line, pencil, straight, tapered, boots-cut, bell-bottom, mermaid, peplum, or the like. In addition, as described above, the attributes of the fashion image may include a neckline, a sleeve length, a detail, a sleeve length, a collar, a fit, a safe, a silhouette, a button shape, a pocket shape, etc.

The image analysis unit 204 may analyze each fashion image to determine what attributes each fashion image consists of. For example, the image analysis unit 204 may analyze an A fashion image to determine that the A fashion image has attributes such as a round neckline, short sleeves, checkered patterns, slim fit, casual style, etc. and analyze a B fashion image to determine that the B fashion image has attributes such as a V neckline, long sleeves, striped patterns, slim fit, feminine style, etc.

The costume registration unit 206 receives a selection of one of the plurality of fashion images from the user terminal 104 and receives, from the user terminal 104, registration of a new digital costume created as at least one of the attributes of the selected fashion image is modified according to input of a user. As described above, the user may select one of the plurality of fashion images on the design modification platform provided by the digital costume modification system 100, and modify at least one of the attributes of the fashion image selected through various design tools, design development programs, etc. For example, the user may modify the neckline, the print, the sleeve length, and the shoulder line among the attributes of the A fashion image, and the new digital costume with the modified new style becomes a secondary creation created from the fashion image of the original creator terminal 102.

The NFT issuance unit 208 issues a first NFT for the new digital costume. As described above, the first NFT may include a unique ID corresponding to the new digital costume, information on the original creator of the fashion image that became the basis of the new digital costume or the original creator terminal 102, and information on the user who created the new digital costume or the user terminal 102. The NFT issuance unit 208 may store the first NFT for the new digital costume in the blockchain system 106, and store the original file of the new digital costume and the metadata of the new digital costume in the repository 108.

The virtual fitting unit 210 authenticates ownership of the first NFT through the blockchain electronic wallet, and activates a virtual fitting function for the new digital costume only for the user terminal 104 for which authentication of the ownership has been completed. Virtual fitting is a function that is executed through a dedicated application installed on the user terminal 104, and is a function of superimposing the new digital costume onto an image of a real world or another virtual image and providing the superimposed image to the user. When the user requests the virtual fitting function, the virtual fitting unit 210 may authenticate the ownership of the first NFT of the user through the blockchain electronic wallet. When it is determined that the user is an owner of the first NFT, the virtual fitting unit 210 activates the virtual fitting function for the new digital costume. In addition, when it is determined that the user is not the owner of the first NFT, the virtual fitting unit 210 deactivates the virtual fitting function for the new digital costume.

When the virtual fitting function is activated, the user may photograph a specific person or mannequin through a photographing means (e.g., a camera) provided in his or her user terminal 104. Here, the person may be, for example, the user himself/herself, a friend, a family, or the like. In addition, the mannequin may be provided on one side of an offline store as a human model having a specific body shape or body size. In this case, the virtual fitting unit 210 may load a virtual avatar having a body shape and body size most similar to the body shape and body size of the specific person or mannequin among a plurality of virtual avatars previously stored in the database (not shown). For example, when 10,000 virtual avatars having different body shapes and body sizes are registered in the database, the virtual fitting unit 210 may load a virtual avatar having a body shape and body size most similar to the body shape and body size of the specific person or mannequin among the 10,000 virtual avatars. Thereafter, the virtual fitting unit 210 may superimpose the new digital costume onto the virtual avatar in the virtual space and then provide the superimposed augmented reality screen to the user terminal for which authentication of the ownership has been completed. In this case, the virtual fitting unit 210 may change a pose of the virtual avatar to correspond to a pose of the specific person or mannequin, and then superimpose the new digital costume onto the virtual avatar in the virtual space. In addition, the virtual fitting unit 210 may change the new digital costume to correspond to the body shape, body size, and pose of the virtual avatar based on the original file and metadata of the new digital costume stored in the storage 108, superimpose the new digital costume onto the mannequin, and then provide the superimposed augmented reality screen to the user terminal 104 for which authentication of the ownership has been completed. In this case, the new digital costume may be superimposed to exactly fit the body shape, body size, and pose of the virtual avatar, and accordingly, a real person may feel as if he or she is wearing a real costume. In particular, by superimposing and providing the new digital costume to a virtual avatar corresponding to a body shape and a body size of a specific person or mannequin photographed by the user, it is possible to provide the user with intuitive information about how well the new digital costume fits a specific body shape and body size desired by the user.

In addition, according to embodiments of the present invention, by exclusively allowing the virtual fitting function (i.e., AR filter function) to be activated only to a user for whom ownership authentication of the first NFT of the new digital costume has been completed after the new digital costume is created, exclusive useful information about the new digital costume may be provided to the user who has ownership of the new digital costume before the make-to-order production of the new digital costume. The activation of the virtual fitting function according to the ownership authentication of the first NFT may operate in the same manner even when the ownership of the first NFT is transferred. For example, when the ownership of the first NFT is transferred to another user, the virtual fitting function for the new digital costume may be activated only for the other user terminal for which authentication of the ownership of the first NFT has been completed. Accordingly, the other user who has purchased the ownership of the first NFT may experience wearing the new digital costume virtually using the other user's terminal, and, due to the virtual wearing function, it is possible to induce make-to-order production of the new digital costume.

The avatar creation unit 212 receives body information including a face type, body type, and body size of the user from the user terminal 104, and creates a personalized avatar corresponding to the body information. As described above, the virtual fitting unit 210 may superimpose the new digital costume onto a virtual avatar most similar to the body shape and body size of a specific person or mannequin photographed by the user terminal 104, and then provide the superimposed augmented reality screen to the user terminal 104 for which authentication of the ownership has been completed. In this case, the user may register a personalized avatar corresponding to his or her body information, and when the personalized avatar is registered, the virtual fitting unit 210 may load the personalized avatar as the virtual fitting function is activated.

To this end, the avatar creation unit 212 may receive body information including a face type, body shape, and body size of the user from the user terminal 104 and then create a personalized avatar corresponding to the body information. For example, the avatar creation unit 212 may learn a human body model according to various types of body information in advance through a set trained model and then input body information input from the user terminal 104 into the trained model to obtain a human body model according to the body information, i.e., a personalized avatar. The personalized avatar may have a face shape, body shape, and body size corresponding to the body information input from the user terminal 104, and thus may reproduce an actual appearance of the user almost as it is. In addition, the personalized avatar created in this manner may be stored in a database in which the plurality of virtual avatars are stored, and other users may receive a virtual fitting service by using one of the plurality of virtual avatars stored in the database.

The virtual fitting unit 210 may superimpose the new digital costume onto the personalized avatar in a virtual space and then provide the superimposed augmented reality screen to the user terminal 104 for which authentication of the ownership of the first NFT and the second NFT has been completed. In this case, the user may have the same experience as if he or she is wearing the new digital costume through the augmented reality screen, and may intuitively check whether the new digital costume is suited to him or her well or fits him or her well.

In addition, since the personalized avatar created by the avatar creation unit 212 is composed of different 3D shapes according to body information of each individual, the NFT issuance unit 208 may issue a second NFT corresponding to the personalized avatar. The second NFT may include a unique ID corresponding to the personalized avatar, and information on a user or user terminal 102 corresponding to the personalized avatar. The NFT issuance unit 208 may store the second NFT for the personalized avatar in the blockchain system 106, and store an original file of the personalized avatar and metadata of the personalized avatar in the repository 108. The ownership of this second NFT may be sold (traded) independently of the ownership of the first NFT. The owner of the first NFT may sell the ownership of his or her first NFT to another user, and in this process, may also sell the ownership of the second NFT that he or she owns to the other user. The other user may purchase only the ownership of the first NFT, and may purchase the ownership of the second NFT if necessary. When there is a personalized avatar similar to the body information of the other user, the other user may purchase the ownership of the second NFT for the personalized avatar, and may retrieve the personalized avatar based on the ownership of the second NFT and then superimpose the personalized avatar onto the new digital costume. The virtual fitting unit 210 may superimpose the new digital costume onto the personalized avatar in the virtual space and then provide the superimposed augmented reality screen to the user terminal 104 for which authentication of the ownership of the first NFT and the second NFT has been completed.

That is, according to the embodiments of the present invention, ownership of the new digital costume and the personalized avatar may be stably traded based on the first NFT and the second NFT, the user who purchases ownership of the first NFT and the second NFT at the same time may be provided the same experience as if he or she is actually wearing the new digital costume in a virtual world. Such an NFT credit issuance platform may provide a high-quality fashion service to a user in that NFT credit issuance platform connects the 1:1 styling experience in the virtual world with the experience in the real world, and ultimately greatly help maximize the sales of shopping malls or fashion malls by encouraging user's desire to purchase.

The sales management unit 214 settles the sales amount for the ownership when the ownership of the first NFT and the second NFT of the user is sold. The ownership of the first NFT and the second NFT of the user may be traded through a blockchain electronic wallet, and the sales management unit 214 may collect such transaction details from the blockchain electronic wallet.

When the ownership of the first NFT of the user is sold, the sales management unit 214 may distribute a portion of the sales amount for the ownership to the original creator of the fashion image that became the basis of the new digital costume. For example, when the ownership of the first NFT of the user is sold, the sales management unit 214 may distribute 95% of the sales amount for the ownership to the creator of the new digital costume and 5% of the sales amount to the original creator of the fashion image that became the basis of the new digital costume. The distribution of the sales amount for the ownership of the first NFT may be performed according to a preset fixed ratio (%), but is not limited thereto, and the ratio may be dynamically changed according to the similarity between the fashion image and the new digital costume. For example, as the similarity between the new digital costume and the fashion image increases, the ratio of the sales amount distributed to the original creator of the fashion image may be increased. The similarity between the new digital costume and the fashion image may vary depending on the degree of matching between attributes included in the new digital costume and the fashion image. That is, as a result of comparing the attributes of the new digital costume with attributes of the fashion image, the number of matching attributes increases, the similarity between the new digital outfit and the fashion image may increase.

In addition, when the ownership of the second NFT of the user is sold, the sales management unit 214 may distribute the sales amount for the ownership to the original owner of the second NFT. For example, when the ownership of the second NFT of the user is sold, the sales management unit 214 may distribute 100% of the sales amount for the ownership to the original owner of the second NFT, that is, the user who has provided the body information corresponding to the personalized avatar.

When the make-to-order production unit 216 receives a make-to-order production request for the new digital costume from the user terminal 104, the make-to-order production unit 216 authenticates ownership of the first NFT of the user terminal 104 through the blockchain electronic wallet, and transmits the make-to-order production request for the new digital costume to the set make-to-order production server 110 only when the authentication of the ownership has been completed. As described above, when receiving the make-to-order production request for the new digital costume from the user terminal 104, the make-to-order production unit 216 may authenticate the ownership of the first NFT of the user terminal 104 through the blockchain electronic wallet. When the authentication of the ownership has been completed, the make-to-order production unit 216 may transmit the make-to-order production request for the new digital costume to the set make-to-order production server 110. The make-to-order production server 110 may obtain an original file and metadata of the new digital costume from the repository 108 according to the make-to-order production request, and transmit the original file and metadata to a set factory server (not shown) to request the make-to-order production of real product for the new digital costume.

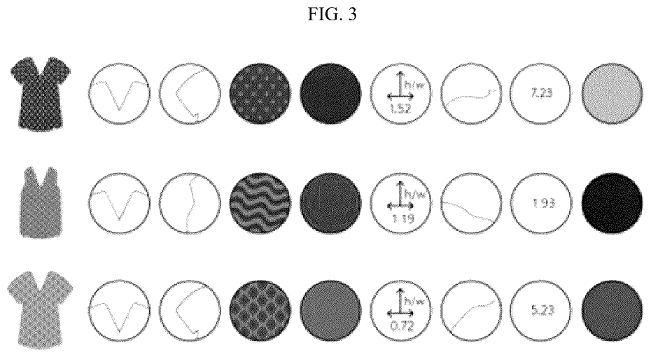

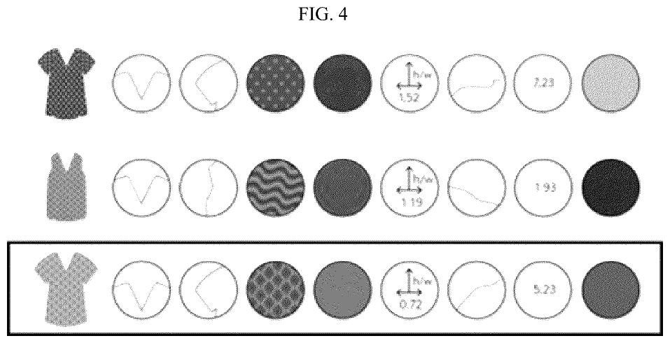

FIG. 3 is an example showing a plurality of fashion images and attributes of the fashion images according to an embodiment of the present invention, and FIG. 4 is an example of selecting one of a plurality of fashion images according to an embodiment of the present invention.

Referring to FIG. 3, the image collection unit 202 may collect a plurality of fashion images from each of the original creator terminals 102. These fashion images may be composed of a plurality of attributes as shown in FIG. 3. The image analysis unit 204 may analyze each collected fashion image to identify attributes constituting each fashion image. That is, the image analysis unit 204 may analyze each fashion image to determine what attributes each fashion image consists of.

Referring to FIG. 4, the user may select one of the plurality of fashion images on a set design recombination platform and modify at least one of the attributes of the selected fashion image through various design tools, design development programs, etc.

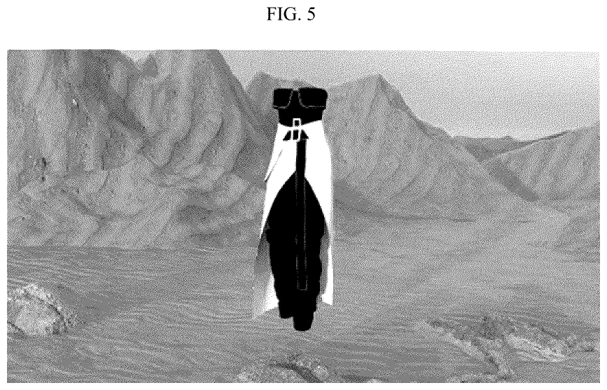

FIG. 5 is an example of a new digital costume according to an embodiment of the present invention. As shown in FIG. 5, the new digital costume may exist in the form of a 3D file online.

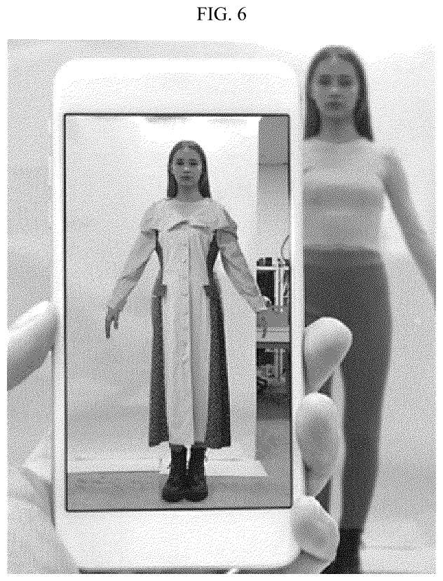

FIG. 6 is an example of providing, by a virtual fitting unit, an augmented reality screen created by superimposing a new digital costume onto a virtual avatar to a user terminal according to an embodiment of the present invention.

As described above, the virtual fitting unit 210 may authenticate the ownership of the first NFT through the blockchain electronic wallet and activate the virtual fitting function for the new digital costume only for the user terminal 104 for which authentication of the ownership has been completed. The virtual fitting unit 210 may load a virtual avatar most similar to a body shape and body size to a specific person or mannequin among a plurality of virtual avatars previously stored in a database when the user terminal photographs the specific person or mannequin through a photographing means, superimpose the new digital costume onto the virtual avatar in a virtual space, and then provide the superimposed augmented reality screen to the user terminal for which authentication of the ownership has been completed. In this case, the virtual fitting unit 210 may change a pose of the virtual avatar to correspond to a pose of the specific person or mannequin and then superimpose the new digital costume onto the virtual avatar in a virtual space.

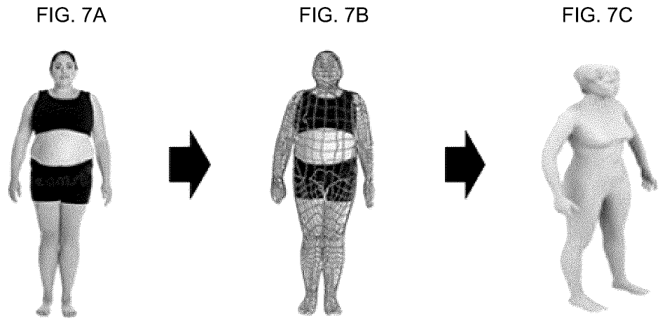

FIGS. 7A to 7C are examples showing a process of creating, by an avatar creating unit, a personalized avatar corresponding to body information of a user according to an embodiment of the present invention.

As described above, the avatar creation unit 212 may receive body information including the face shape, body shape, and body size of the user (or a user photo including the body information from the user terminal 104 and then create a personalized avatar corresponding to the body information. For example, the avatar creation unit 212 may learn a human body model according to various types of body information in advance through a set trained model and then input the body information input from the user terminal 104 into the trained model to obtain a human body model according to the body information, i.e., a personalized avatar. However, a method of creating the personalized avatar by the avatar generation unit 212 is not limited thereto. For example, the avatar creation unit 212 may classify a 2D image (i.e., a user photo) including body information in units of predetermined pixels, detect a predetermined number or more contour points from the 2D image, set a depth value for 3D conversion for every pixel based on the detected contour points, calculate 3D processing path coordinates based on the depth value, and restore the 2D image to a 3D human body model.

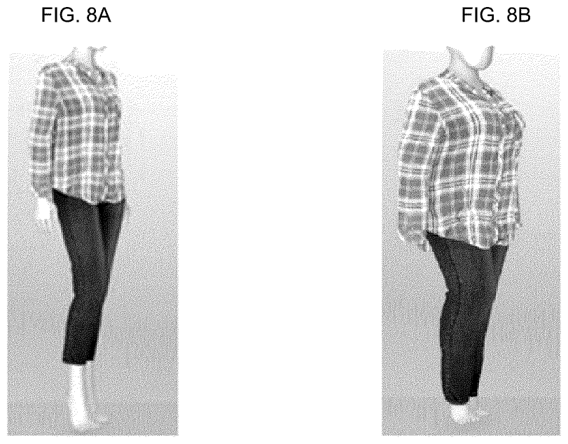

FIGS. 8A and 8B are examples of providing, by the virtual fitting unit 210, an augmented reality screen created by superimposing a new digital costume onto a personalized avatar to the user terminal 104 according to an embodiment of the present invention.

As shown in FIGS. 8A and 8B, the personalized avatar may have different forms according to the body information input during the creating process thereof, and the new digital costume on the augmented reality screen may also be differently displayed according to the body information of the personalized avatar. Accordingly, when a personalized avatar similar to body information of a user exists, the user may purchase ownership of the second NFT for the personalized avatar and then superimpose the new digital costume onto the personalized avatar based on the ownership of the second NFT.

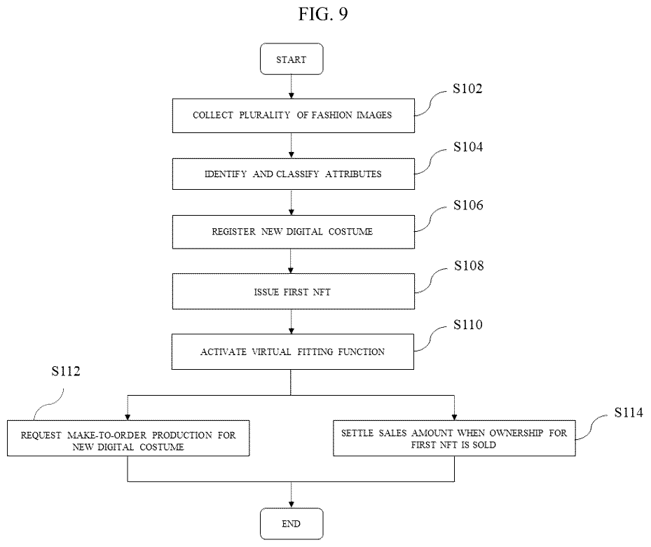

FIG. 9 is a flowchart for describing a digital costume recombination method according to a first embodiment of the present invention. Although the method is described by dividing the method into a plurality of steps, at least some of the steps may be performed in a different order, may be combined with another step to be performed together, omitted, or divided into sub-steps, or may be performed by being added with one or more steps (not shown).

In step S102, the image collection unit 202 collects a plurality of fashion images.

In step S104, the image analysis unit 204 analyzes the collected fashion images to identify attributes constituting each fashion image.

In step S106, the costume registration unit 206 receives registration of a new digital costume from the user terminal 104. The costume registration unit 206 may receive a selection of one of the plurality of fashion images from the user terminal 104, and may receive, from the user terminal 104, registration of the new digital costume that is created as at least one of the attributes of the selected fashion image is modified according to input of a user.

In step S108, the NFT issuance unit 208 issues a first NFT for the new digital costume.

In step S110, the virtual fitting unit 210 activates a virtual fitting function for the new digital costume.

In step S112, when the make-to-order production unit 216 receives a make-to-order production request for the new digital costume from the user terminal 104, the make-to-order production unit 216 authenticates the ownership of the first NFT of the user terminal 104 through the blockchain electronic wallet, and transmits the make-to-order production request for the new digital costume to the set make-to-order production server 110 only when authentication of the ownership has been completed.

In step S114, when the ownership of the first NFT of the user is sold, the sales management unit 214 distributes a portion of the sales amount for the ownership to the original creator of the selected fashion image.

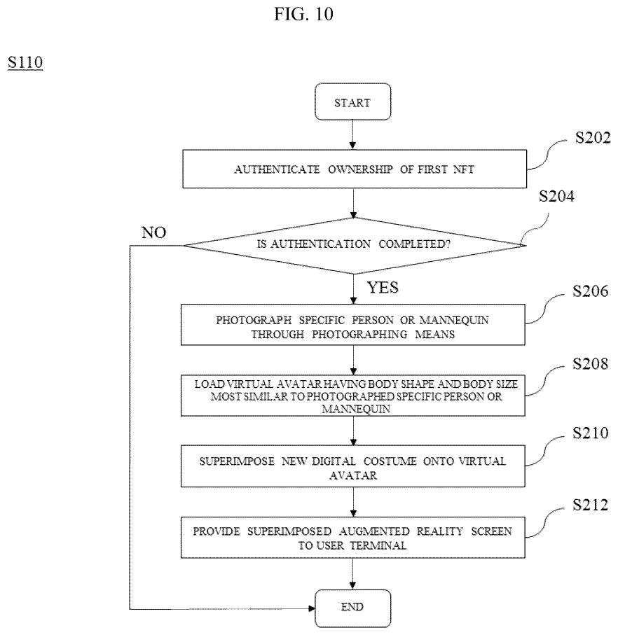

FIG. 10 is a flowchart for describing step S110 of FIG. 9.

In steps S202 and S204, the virtual fitting unit 210 authenticates ownership of the first NFT through the blockchain electronic wallet.

In step S206, the virtual fitting unit 210 activates a virtual fitting function for the new digital costume only for the user terminal for which authentication of the ownership has been completed. In this case, the user may photograph a specific person or mannequin through a photographing means provided in the user terminal 104.

In step S208, the virtual fitting unit 210 loads a virtual avatar having a body shape and a body size most similar to the specific person or mannequin among the plurality of virtual avatars previously stored in the database.

In step S210, the virtual fitting unit 210 superimposes the new digital costume onto the virtual avatar in a virtual space.

In step S212, the virtual fitting unit 210 provides the superimposed augmented reality screen to the user terminal for whom the authentication of the ownership has been completed.

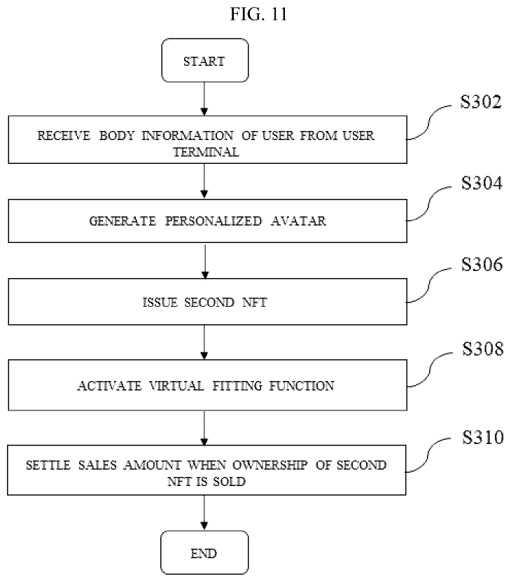

FIG. 11 is a flowchart for describing a digital costume recombination method according to a second embodiment of the present invention.

In step S302, the avatar generation unit 212 receives body information including a face type, a body shape, and a body size of a user from the user terminal 104.

In step S304, the avatar generation unit 212 creates a personalized avatar corresponding to the body information.

In step S306, the NFT issuance unit 208 issues a second NFT corresponding to the personalized avatar. The ownership of the second NFT may be sold independently of the ownership of the first NFT.

In step S308, the virtual fitting unit 210 activates a virtual fitting function for the personalized avatar. The virtual fitting unit 210 may authenticate the ownership of the second NFT through the blockchain electronic wallet and activate the virtual fitting function for the personalized avatar only for the user terminal 104 for which authentication of the ownership has been completed. In this case, the virtual fitting unit 210 may authenticate the ownership of each of the first NFT and the second NFT, and when all ownership of the first NFT and the second NFT is completely authenticated, the virtual fitting unit 210 may superimpose the new digital costume onto the personalized avatar in the virtual space and then provide the superimposed augmented reality screen to the user terminal 104 for which the authentication of the ownership of the first NFT and the second NFT has been completed.

In step S310, when the ownership of the second NFT of the user is sold, the sales management unit 212 distributes the sales amount for the ownership to the original owner of the second NFT.

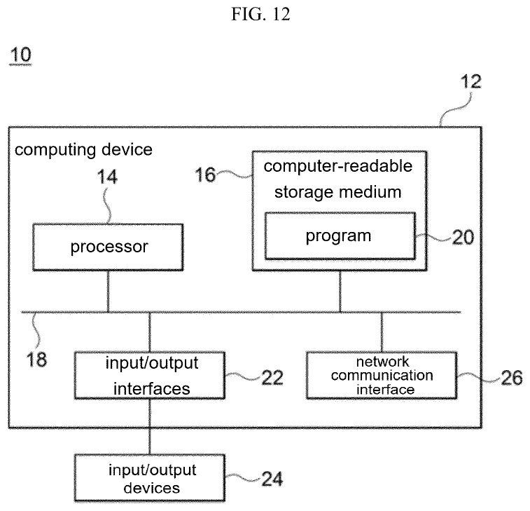

FIG. 12 is a block diagram for describing a computing environment including a computing device suitable for use in exemplary embodiments. In the illustrated embodiment, respective components may have different functions and capabilities other than those described below, and may include additional components in addition to those described below.

The illustrated computing environment 10 includes a computing device 12. In one embodiment, the computing device 12 may be a digital costume recombination system 100, or one or more components included in the digital costume recombination system 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured so that the computer-executable instruction or program code, program data, and/or other suitable forms of information are stored. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

Although representative embodiments of the present disclosure have been described in detail, a person skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents to the claims.

1: A system for recombining digital clothes based on blockchain, comprising:
an image collection unit configured to collect a plurality of fashion images;
an image analysis unit configured to analyze each collected fashion image to identify attributes constituting each fashion image;
a costume registration unit configured to receive a selection of one of the plurality of fashion images from a user terminal and receives, from the user terminal, registration of a new digital costume created as at least one of the attributes of the selected fashion image is transformed according to input of a user;
a non-fungible token (NFT) issuance unit configured to issue a first NFT for the new digital costume;
a virtual fitting unit configured to authenticate an ownership of the first NFT through a blockchain electronic wallet and activate a virtual fitting function for the new digital costume only for the user terminal for which authentication of the ownership has been completed;
a sales management unit configured to distribute a portion of the sales amount for the ownership to an original creator of the selected fashion image when the ownership of the first NFT of the user is sold; and
an avatar creation unit configured to receive body information including a face shape, a body shape, and a body size of the user from the user terminal and create a personalized avatar corresponding to the body information,
wherein the NFT issuance unit issues a second NFT corresponding to the personalized avatar, and
an ownership of the second NFT is sold independently of the ownership of the first NFT.

2: The system of claim 1, wherein the attributes constituting each fashion image include at least two or more of a material, a print, a style, a color, a shoulder line, a sleeve length, a neckline, a collar, a fit, a safe, and a silhouette.

3: The system of claim 1, wherein the virtual fitting unit is configured to load a virtual avatar having the most similar body shape and body size to a specific person or mannequin among a plurality of virtual avatars previously stored in a database when the user terminal photographs the specific person or mannequin through a photographing unit, and superimpose the new digital costume onto the virtual avatar in a virtual space, and then provide the superimposed augmented reality screen to the user terminal for which the authentication of the ownership has been completed.

4: The system of claim 3, wherein the virtual fitting unit is configured to change a pose of the virtual avatar to correspond to a pose of the specific person or mannequin, superimpose the new digital costume onto the virtual avatar in the virtual space, and then provide the superimposed augmented reality screen to the user terminal for which the authentication of the ownership has been completed.

5: The system of claim 1, wherein the virtual fitting unit is configured to superimpose the new digital costume onto the personalized avatar in a virtual space and then provide the superimposed augmented reality screen to a user terminal for which authentication of the ownership of the first NFT and the second NFT has been completed.

6: The system of claim 1, further comprising:
a make-to-order production unit is configured to authenticate the ownership of the first NFT of the user terminal through the blockchain electronic wallet when receiving a make-to-order production request for the new digital costume from the user terminal, and transmit the make-to-order production request for the new digital costume to a set make-to-order production server only when the authentication of the ownership has been completed.

7: A method for recombining digital clothes based on blockchain comprising:
collecting, by an image collection unit, a plurality of fashion images;
analyzing, by an image analysis unit, each collected fashion image to identify attributes constituting each fashion image;
receiving, by a costume registration unit, a selection of one of the plurality of fashion images from a user terminal;
receiving, by costume registration unit, registration of a new digital costume, which is created as at least one of attributes of the selected fashion image is transformed according to input of a user, from the user terminal;
issuing, by an NFT credit issuance unit, a first non-fungible token (NFT) for the new digital costume;
authenticating, by a virtual fitting unit, ownership of the first NFT through a blockchain electronic wallet;
activating, by the virtual fitting unit, a virtual fitting function for the new digital costume only for the user terminal for which authentication of the ownership has been completed;
receiving, by an avatar creation unit, body information including a face shape, body shape, and body size of the user from the user terminal;
creating, by the avatar creation unit, a personalized avatar corresponding to the body information;
issuing, by the NFT issuance unit, a second NFT corresponding to the personalized avatar; and
distributing, by a sales management unit, a portion of the sales amount for the ownership to an original creator of the selected fashion image when the ownership of the first NFT of the user is sold,
wherein the ownership of the second NFT is sold independently of the ownership of the first NFT.

8: The method of claim 7, wherein the attributes constituting each fashion image include at least two or more of a material, a print, a style, a color, a shoulder line, sleeve length, a neckline, a collar, a fit, a safe, and a silhouette.

9: The method of claim 7, further comprising:
after the activating of the virtual fitting function for the new digital costume, loading, by the virtual fitting unit, a virtual avatar having the most similar body shape and body size to a specific person or mannequin among a plurality of virtual avatars previously stored in a database when the user terminal photographs the specific person or mannequin through a photographing unit, superimposing the new digital costume onto the virtual avatar in a virtual space, and then providing the superimposed augmented reality screen to the user terminal for which the authentication of the ownership has been completed.

10: The method of claim 9, wherein, in the providing of the augmented reality screen to the user terminal, a pose of the virtual avatar is changed to correspond to a pose of the specific person or mannequin, the new digital costume is superimposed onto the virtual avatar in the virtual space, and then the superimposed augmented reality screen is provided to the user terminal for which the authentication of the ownership has been completed.

11: The method of claim 7, further comprising:
after the creating of the personalized avatar, superimposing, by the virtual fitting unit, the new digital costume onto the personalized avatar in a virtual space and then providing the superimposed augmented reality screen to a user terminal for which authentication of the ownership of the first NFT and the second NFT has been completed.

12: The method of claim 7, further comprising:
authenticating, by a make-to-order production unit, the ownership of the first NFT of the user terminal through the blockchain electronic wallet when receiving a make-to-order production request for the new digital costume from the user terminal; and
transmitting, by the make-to-order production unit, the make-to-order production request for the new digital costume to a set make-to-order production server only when the authentication of the ownership has been completed.
